(19) United States
(12) Patent Application Publication
(10) Pub. No.: US 2019/0143366 A1
(43) Pub. Date: May 16, 2019

(54) SYSTEMS FOR AND METHODS OF FORMING COATINGS THAT COMPRISE NON-CARBON-BASED TOPOLOGICAL INSULATORS

(71) Applicant: The Boeing Company, Chicago, IL (US)

(72) Inventors: Jeffrey H. Hunt, Thousand Oaks, CA (US); Angela W. Li, Everett, WA (US); Wayne R. Howe, Irvine, CA (US)

(21) Appl. No.: 15/815,561

(22) Filed: Nov. 16, 2017

(51) Int. Cl. B05D 1/04; B05D 3/12

(52) U.S. Cl. CPC B05D 1/04; B05D 3/12

(57) ABSTRACT

A method of forming a coating can include: preparing a substrate surface with adherent characteristics; applying charge of a first polarity to at least one non-carbon-based topological insulator with selected optical transmittance; and/or applying the charged at least one non-carbon-based topological insulator to the substrate surface to provide a topological insulator layer on the substrate surface. The at least one non-carbon-based topological insulator can have one or more of selected optical transmittance, selected thermal conductivity, selected electrical conductivity, or selected electrical resistivity.

### FIELD

The subject matter disclosed herein generally relates to coatings that comprise non-carbon-based topological insulators. The subject matter disclosed herein also relates to systems for and methods of forming coatings that comprise non-carbon-based topological insulators.

### BACKGROUND

Coatings generally may be used for various purposes, such as providing protection from the environment; improving electrical, mechanical, or optical properties; enhancing chemical resistance, corrosion resistance, or fire resistance; or providing hydrophilic or hydrophobic characteristics.

Certain coatings can exhibit specific advantages when compared to other known coatings. Such advantages can include, for example, improved protection from ultraviolet radiation or enhanced fire retardancy.

Many industries, such as the aerospace, automotive, defense, electronics, maritime, and rail-transport industries, continually seek to push the boundaries of what has come before in coating technologies. Thus, there is a need for improved coatings, as well as improved systems for and methods of forming coatings.

### SUMMARY

The present disclosure is directed to coatings that comprise non-carbon-based topological insulators, and systems for and methods of forming coatings that comprise non-carbon-based topological insulators.

In some examples, a method of forming a coating can include: preparing a substrate surface with adherent characteristics; applying charge of a first polarity to at least one non-carbon-based topological insulator with selected optical transmittance; and/or applying the charged at least one non-carbon-based topological insulator to the substrate surface to provide a topological insulator layer on the substrate surface.

In some examples, the first polarity can be positive.

In some examples, the first polarity can be negative.

In some examples, the preparing of the substrate surface with the adherent characteristics can comprise applying charge of a second polarity, different in sign relative to the first polarity, to the substrate surface.

In some examples, the first polarity can be positive, and the second polarity can be negative or ground.

In some examples, the first polarity can be negative, and the second polarity can be positive or ground.

In some examples, the method can further comprise: rolling an adhesive roller over the topological insulator layer to remove some, but not all, of the topological insulator layer.

In some examples, the at least one non-carbon-based topological insulator can comprise a three-dimensional, non-carbon-based topological insulator.

In some examples, a single crystal layer of the at least one three-dimensional, non-carbon-based topological insulator can have optical transmittance greater than or equal to 98% for electromagnetic radiation at normal incidence with a wavelength greater than or equal to 200 nanometers (“nm”) and less than or equal to 800 nm.

In some examples, a method of forming a coating can include: preparing a substrate surface with adherent characteristics; applying charge of a first polarity to at least one non-carbon-based topological insulator with selected thermal conductivity; and/or applying the charged at least one non-carbon-based topological insulator to the substrate surface to provide a topological insulator layer on the substrate surface.

In some examples, the first polarity can be positive.

In some examples, the first polarity can be negative.

In some examples, the preparing of the substrate surface with the adherent characteristics can comprise applying charge of a second polarity, different in sign relative to the first polarity, to the substrate surface.

In some examples, the first polarity can be positive, and the second polarity can be negative or ground.

In some examples, the first polarity can be negative, and the second polarity can be positive or ground.

In some examples, the method can further comprise: rolling an adhesive roller over the topological insulator layer to remove some, but not all, of the topological insulator layer.

In some examples, the at least one non-carbon-based topological insulator can comprise a three-dimensional, non-carbon-based topological insulator.

In some examples, the at least one non-carbon-based topological insulator can have thermal conductivity less than or equal to 100 Watts per meter-degree Kelvin (“W/(m-K)”) at 300 K.

In some examples, a method of forming a coating can include: preparing a substrate surface with adherent characteristics; applying charge of a first polarity to at least one non-carbon-based topological insulator with selected electrical conductivity; and/or applying the charged at least one non-carbon-based topological insulator to the substrate surface to provide a topological insulator layer on the substrate surface.

In some examples, the first polarity can be positive.

In some examples, the first polarity can be negative.

In some examples, the preparing of the substrate surface with the adherent characteristics can comprise applying charge of a second polarity, different in sign relative to the first polarity, to the substrate surface.

In some examples, the first polarity can be positive, and the second polarity can be negative or ground.

In some examples, the first polarity can be negative, and the second polarity can be positive or ground.

In some examples, the method can further comprise: rolling an adhesive roller over the topological insulator layer to remove some, but not all, of the topological insulator layer.

In some examples, the at least one non-carbon-based topological insulator can comprise a three-dimensional, non-carbon-based topological insulator.

In some examples, the at least one non-carbon-based topological insulator can have electrical conductivity greater than or equal to 5×10³ siemens per meter (“S/m”) at 300 K and less than or equal to 5×10⁷ S/m at 300 K.

In some examples, a method of forming a coating can include: preparing a substrate surface with adherent characteristics; applying charge of a first polarity to at least one non-carbon-based topological insulator with selected electrical resistivity; and/or applying the charged at least one non-carbon-based topological insulator to the substrate surface to provide a topological insulator layer on the substrate surface.

In some examples, the first polarity can be positive.

In some examples, the first polarity can be negative.

In some examples, the preparing of the substrate surface with the adherent characteristics can comprise applying charge of a second polarity, different in sign relative to the first polarity, to the substrate surface.

In some examples, the first polarity can be positive, and the second polarity can be negative or ground.

In some examples, the first polarity can be negative, and the second polarity can be positive or ground.

In some examples, the method can further comprise: rolling an adhesive roller over the topological insulator layer to remove some, but not all, of the topological insulator layer.

In some examples, the at least one non-carbon-based topological insulator can comprise a three-dimensional, non-carbon-based topological insulator.

In some examples, the at least one non-carbon-based topological insulator can have electrical resistivity greater than or equal to 1×10⁻⁵ Ohm-meter (“Ω-m”) at 300 K and less than or equal to 1 Ω-m at 300 K.

It is to be understood that both the foregoing general description and the following detailed description are exemplary and explanatory only, and are not restrictive of the present teachings, as claimed.

### DRAWINGS

The above and/or other aspects and advantages will become more apparent and more readily appreciated from the following detailed description of examples, taken in conjunction with the accompanying drawings, in which:

FIG. 1A shows a sectional view of components involved in a method of and/or a system for forming a coating, according to some examples of the disclosed methods and systems;

FIG. 1B shows a sectional view of components involved in a method of and/or a system for forming a coating, according to some examples of the disclosed methods and systems;

FIG. 1C shows a sectional view of components involved in a method of and/or a system for forming a coating, according to some examples of the disclosed methods and systems;

FIG. 2 shows a sectional view of components involved in a method of and/or a system for forming a coating, according to some examples of the disclosed methods and systems;

FIG. 3 shows a sectional view of components involved in a method of and/or a system for forming a coating, according to some examples of the disclosed methods and systems;

FIG. 4 shows a sectional view of components involved in a method of and/or a system for forming a coating, according to some examples of the disclosed methods and systems;

FIG. 5 shows a sectional view of components involved in a method of and/or a system for forming a coating, according to some examples of the disclosed methods and systems;

FIG. 6 shows a perspective view of components involved in a method of and/or a system for forming a coating, according to some examples of the disclosed methods and systems; and

FIG. 7 shows a sectional view of components involved in a method of and/or a system for forming a coating, according to some examples of the disclosed methods and systems, taken along line 7-7 of FIG. 6.

### DETAILED DESCRIPTION

Exemplary aspects will now be described more fully with reference to the accompanying drawings. Examples of the disclosure, however, can be embodied in many different forms and should not be construed as being limited to the examples set forth herein. Rather, these examples are provided so that this disclosure will be thorough and complete, and will fully convey the scope to one of ordinary skill in the art. In the drawings, some details may be simplified and/or may be drawn to facilitate understanding rather than to maintain strict structural accuracy, detail, and/or scale. For example, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, or section could be termed a second element, component, region, layer, or section without departing from the teachings of examples.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation(s) depicted in the figures.

The terminology used herein is for the purpose of describing particular examples only and is not intended to be limiting of examples. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as understood by one of ordinary skill in the art. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

The present disclosure is directed to coatings that comprise non-carbon-based topological insulators.

In some examples, a method of forming a coating comprises: preparing a substrate surface with adherent characteristics; applying charge of a first polarity to at least one non-carbon-based topological insulator with selected optical transmittance; and applying the charged at least one non-carbon-based topological insulator to the substrate surface to provide a topological insulator layer on the substrate surface.

As used herein, the term “substrate” means any solid on which a coating or layer of different material can be deposited.

As used herein, the term “adherent” means tends to stick to.

As used herein, the term “carbon” means the nonmetallic element of atomic number 6, including any isotopes thereof. Forms of carbon include, for example, amorphous carbon, diamond, graphene, and graphite.

As used herein, the term “topological insulator” means a two-dimensional (“2D”) or three-dimensional (“3D”) material with time-reversal symmetry and topologically protected edge states (2D) or surface states (3D). For example, a 2D topological insulator generally will not conduct current across the surface of the 2D material, but can carry current along the edges of the 2D material. In another example, a 3D topological insulator generally will not conduct current through the bulk of the 3D material, but can carry current along the surface of the 3D material.

As used herein, the term “non-carbon-based topological insulator” means a topological insulator whose crystal structure does not include carbon.

Some 2D, non-carbon-based topological insulators can comprise, consist essentially of, or consist of, for example, one or more of antimony (Sb), bismuth (Bi), selenium (Se), or tellurium (Te), or combinations thereof.

Some 2D, non-carbon-based topological insulators can comprise, consist essentially of, or consist of, but are not limited to, CdTe/HgTe/CdTe quantum wells, AlSb/InAs/GaSb/AlSb quantum wells, Bi bilayers, monolayer low-buckled HgSe, monolayer low-buckled HgTe, strained HgTe, or silicene, or combinations thereof.

Some 3D, non-carbon-based topological insulators can comprise, consist essentially of, or consist of, for example, one or more of antimony (Sb), bismuth (Bi), selenium (Se), or tellurium (Te), or combinations thereof.

The at least one non-carbon-based topological insulator can comprise, consist essentially of, or consist of, but is not limited to, one or more of Bi₁₋ₓSbₓ (0<x<1) (e.g., Bi_{0.9}Sb_{0.1}), Bi₁₋ₓTeₓ (0<x<1), Bi₁₋ₓTeₓ (0<x<1), Sb, Bi₂Se₃, Bi₂Te₃, Sb₂Te₃, Bi₂Te₂Se, (Bi,Sb)₂Te₃ (e.g., (Bi_{0.2}Sb_{0.8})₂Te₃), Bi₂₋ₓSbₓTe_{3-y}Se_{y} (0≤x≤2; 0≤y≤3), Bi₂₋ₓSbₓTe_{3-y}Se_{y} (0≤x≤2; 1≤y≤3) (e.g., Bi₂Te_{1.95}Se_{1.05}, BiSbTe_{1.25}Se_{1.75}), Bi₂Te_{1.6}S_{1.4}, Bi_{1.1}Sb_{0.9}Te₂S, Sb₂Te₂Se, Bi₂(Te,Se)₂(Se,S), TlBiSe₂, TlBiTe₂, TlBi(S₁₋ₓ,Seₓ)₂ (0.5≤x≤1), Pb(Bi₁₋ₓSbₓ)₂Te₄ (0≤x≤1), PbBi₂Te₄, PbSb₂Te₄, PbBi₄Te₇, GeBi₂Te₄, GeBi₄₋ₓSbₓTe₇ (0≤x≤4), (PbSe)₅(Bi₂Se₃)₃, (PbSe)₅(Bi₂Se₃)₆, (Bi₂)(Bi₂Se_{2.6}S_{0.4}), Bi₄Se₃, Bi₄Se_{2.6}S_{0.4}, (Bi₂)(Bi₂Te₃)₂, SnTe, Pb₁₋ₓSnₓSe (0<x<1), Pb₁₋ₓSnₓTe (0<x<1), Pb_{0.77}Sn_{0.23}Se, Bi_{1.84-x}Fe_{0.16}CaₓSe₃ (0≤x<1.84), Cr_{0.08}(Bi_{0.1}Sb_{0.9})_{1.92}Te₃, (DyₓBi₁₋ₓ)₂Te₃ (0<x<1), NiₓBi₂₋ₓSe₃ (0<x<2), (HoₓBi₁₋ₓ)₂Se₃ (0≤x<1), Ag₂Te, SmB₆, Bi₁₄Rh₃I₉, Bi₂₋ₓCaₓSe₃ (0<x<2), Bi₂₋ₓMnₓTe₃ (0<x<2) (e.g., Bi_{1.91}Mn_{0.09}Te₃, Bi_{1.96}Mn_{0.04}Te₃, Bi_{1.98}Mn_{0.02}Te₃), Ba₂BiBrO₆, Ba₂BiIO₆, Ca₂BiBrO₆, Ca₂BiIO₆, Sr₂BiBrO₆, or Sr₂BiIO₆, or combinations thereof.

As used herein, the term “layer” means a thickness of material laid on, formed on, or spread over a surface, body, or portion of a surface or body. A layer can cover the surface, body, or portion of the surface or body, or form an overlying part or segment of material that covers the surface, body, or portion of the surface or body. A layer can have constant or variable thickness.

The applying of the charge of the first polarity to the at least one non-carbon-based topological insulator can comprise applying a positive or negative charge to the at least one non-carbon-based topological insulator using, for example, a corona gun or a tribo gun. Other technologies (e.g., electrostatic fluidized bed, electrostatic magnetic brush), as appropriate, can be used to apply the charge of the first polarity to the at least one non-carbon-based topological insulator, as understood by one of ordinary skill in the art.

The at least one non-carbon-based topological insulator can hold the charge of the first polarity for a considerable period of time, such as longer than necessary to complete applying the charged at least one non-carbon-based topological insulator to the substrate surface to provide a topological insulator layer on the substrate surface (e.g., on the order of minutes or hours).

The first polarity can be positive. In the alternative, the first polarity can be negative. Because, as discussed below, the material of the substrate surface can prove advantageous for a positive polarity or for a negative polarity, the affinity of the substrate surface for a charge of a second polarity can influence the choice of the first polarity.

The at least one non-carbon-based topological insulator can comprise at least one two-dimensional (“2D”), non-carbon-based topological insulator. In some examples, the at least one non-carbon-based topological insulator can comprise at least one three-dimensional (“3D”), non-carbon-based topological insulator. In either the 2D or 3D case, one or more dopants can be used to tune the at least one non-carbon-based topological insulator in order to achieve one or more desired properties, such as selected optical transmittance, selected thermal conductivity, selected electrical conductivity, or selected electrical resistivity, as understood by one of ordinary skill in the art.

Individual atoms have quantized discrete energy levels which are occupied by each individual atom's electrons. In the case of a solid, however, many atoms are in close proximity to one another and the discrete energy levels of the individual atoms combine to form so-called “energy bands.” These energy bands are defined by energies that can be determined by spectroscopically measuring the bandgap in the solid, for example, according to known spectroscopic methods, such as wavelength modulation spectroscopy. Generally, photons having energy values that lie below the bandgap will transmit through the solid, while photons having energy values at or above the bandgap will be strongly absorbed. In wavelength modulation spectroscopy, the relative absorption of the photons is correlated with the band density of states.

The energy bands describe electron behavior within the solid. For example, in these energy bands, electron energy can be described as a function of the electron's wave-vector as the electron travels through the solid. Macroscopic behavior of many electrons in the solid—electrical conductivity, thermal conductivity, and the like—result from the band structure. Ordinarily, the geometric construction of solids do not have an effect on the band structure. However, for very thin solids such as graphene, not only does the solid's geometry change, but so too does its band structure. That is, for thin solids, the electron behavior changes as the geometry of the solid changes. Thus, whether a solid is a defined as a “2D-structure” or a “3D-structure” depends on the solid's band structure. For example, graphene is monoatomic and its 2D band structure only exists when it is one atomic layer thick. The addition of more atomic layers (e.g., from single-layer graphene to few-layer graphene) not only increases graphene's thickness, but also changes its band structure toward its 3D configuration. In contrast, topological insulators comprise several different atoms and can be molecularly engineered. Thus, unlike graphene which faces the aforementioned issues to changes in its band structure, a topological insulator largely maintains its 2D band structure even as the material's thickness is changed.

The at least one non-carbon-based topological insulator can have selected optical transmittance.

As used herein, the term “optical transmittance” means the fraction of incident electromagnetic power that is transmitted through a substance, mixture, or material.

The selected optical transmittance can provide improved optical properties, such as improved optical clarity, improved transparency, and/or improved protection from ultraviolet radiation. This can be accomplished by controlling optical transmittance and/or optical non-transmittance—including one or both of reflection or absorption—over spectral regimes defined by the desired use(s). The at least one non-carbon-based topological insulator can be tuned to achieve this type of control, which provides significant flexibility in design. The effects of such control can be measured, for example, using standard laboratory optical equipment, as understood by one of ordinary skill in the art.

The at least one non-carbon-based topological insulator with the selected optical transmittance can comprise at least one two-dimensional, non-carbon-based topological insulator. The at least one non-carbon-based topological insulator with the selected optical transmittance can comprise at least one three-dimensional, non-carbon-based topological insulator.

The optical transmittance of the at least one non-carbon-based topological insulator can be measured using, for example, a spectrometer over a broad range of wavelengths (such as when measuring transmitted light across the visible spectrum) or a narrow range of wavelengths (such as when measuring reflected laser light at a specific wavelength). However, any method of measuring the optical transmittance not inconsistent with the present application can be used, including any suitable instrumentation. The measured wavelengths may or may not be within the range of visible light (e.g., ultraviolet, visible light, infrared).

For example, a single crystal layer of the at least one non-carbon-based topological insulator can have an optical transmittance greater than or equal to 90%, greater than or equal to 95%, greater than or equal to 96%, greater than or equal to 97%, greater than or equal to 98%, greater than or equal to 98.5%, greater than or equal to 99%, or greater than or equal to 99.5% for electromagnetic radiation at normal incidence with a wavelength greater than or equal to 200 nanometers (“nm”) and less than or equal to 800 nm (e.g., visible light plus ultraviolet and infrared). One or more dopants can be used to tune the at least one non-carbon-based topological insulator in order to achieve these levels of optical transmittance, as understood by one of ordinary skill in the art.

In another example, a 100-crystal-layer thickness of the at least one non-carbon-based topological insulator can have an optical transmittance greater than or equal to 30% and less than or equal to 90%, greater than or equal to 40% and less than or equal to 85%, or greater than or equal to 50% and less than or equal to 80% for electromagnetic radiation at normal incidence with a wavelength greater than or equal to 200 nm and less than or equal to 800 nm. One or more dopants can be used to tune the at least one non-carbon-based topological insulator in order to achieve these levels of optical transmittance, as understood by one of ordinary skill in the art.

A single crystal layer of the at least one non-carbon-based topological insulator, for example, generally is more flexible and has a higher optical transmittance than a 100-crystal-layer thickness of the at least one non-carbon-based topological insulator. In contrast, a 100-crystal-layer thickness of the at least one non-carbon-based topological insulator, for example, generally is stronger than a single crystal layer of the at least one non-carbon-based topological insulator.

For applications in which signal level and signal-to-noise ratio of an optical beam are relatively high, a lower value of optical transmittance can be suitable. However, for applications in which signal level, signal-to-noise ratio, or both are relatively low (e.g., where every bit of signal matters), a higher value of optical transmittance can be required for satisfactory performance. Availability, cost, environmental issues, and other factors also can play into selection of the at least one non-carbon-based topological insulator.

In yet another example, a single crystal layer of the at least one non-carbon-based topological insulator can have an optical transmittance greater than or equal to 90%, greater than or equal to 95%, greater than or equal to 96%, greater than or equal to 97%, greater than or equal to 98%, greater than or equal to 98.5%, greater than or equal to 99%, or greater than or equal to 99.5% for electromagnetic radiation at normal incidence with a wavelength greater than or equal to 400 nm and less than or equal to 700 nm (e.g., 400 nm-700 nm approximately representing the spectrum of visible light). One or more dopants can be used to tune the at least one non-carbon-based topological insulator in order to achieve these levels of optical transmittance, as understood by one of ordinary skill in the art.

In still another example, a 100-crystal-layer thickness of the at least one non-carbon-based topological insulator can have an optical transmittance greater than or equal to 30% and less than or equal to 90%, greater than or equal to 40% and less than or equal to 85%, or greater than or equal to 50% and less than or equal to 80% for electromagnetic radiation at normal incidence with a wavelength greater than or equal to 400 nm and less than or equal to 700 nm. One or more dopants can be used to tune the at least one non-carbon-based topological insulator in order to achieve these levels of optical transmittance, as understood by one of ordinary skill in the art.

In yet still another example, a single crystal layer of the at least one non-carbon-based topological insulator can have an optical transmittance greater than or equal to 90%, greater than or equal to 95%, greater than or equal to 96%, greater than or equal to 97%, greater than or equal to 98%, greater than or equal to 98.5%, greater than or equal to 99%, or greater than or equal to 99.5% for electromagnetic radiation at normal incidence with a wavelength equal to 400 nm, 450 nm, 500 nm, 550 nm, 600 nm, 650 nm, or 700 nm (e.g., visible light). One or more dopants can be used to tune the at least one non-carbon-based topological insulator in order to achieve these levels of optical transmittance, as understood by one of ordinary skill in the art.

In a further example, a 100-crystal-layer thickness of the at least one non-carbon-based topological insulator can have an optical transmittance greater than or equal to 30% and less than or equal to 90%, greater than or equal to 40% and less than or equal to 85%, or greater than or equal to 50% and less than or equal to 80% for electromagnetic radiation at normal incidence with a wavelength equal to 400 nm, 450 nm, 500 nm, 550 nm, 600 nm, 650 nm, or 700 nm. One or more dopants can be used to tune the at least one non-carbon-based topological insulator in order to achieve these levels of optical transmittance, as understood by one of ordinary skill in the art.

The at least one non-carbon-based topological insulator can have selected thermal conductivity.

As used herein, the term “thermal conductivity” means the ability to transfer heat through a substance, mixture, or material.

The selected thermal conductivity can provide improved thermodynamic properties, such as improved protection from the environment, improved control over energy dissipation, and/or improved control over energy retention. In some examples, if the at least one non-carbon-based topological insulator is adjacent to another material, lower values of thermal conductivity can indicate better protection of the adjacent material against changes in ambient temperature by the at least one non-carbon-based topological insulator. In some examples, if the at least one non-carbon-based topological insulator is adjacent to another material, higher values of thermal conductivity can indicate better dissipation of heat away from the adjacent material through the at least one non-carbon-based topological insulator.

In some examples, the at least one non-carbon-based topological insulator with the selected thermal conductivity can comprise at least one two-dimensional, non-carbon-based topological insulator. In some examples, the at least one non-carbon-based topological insulator with the selected thermal conductivity can comprise at least one three-dimensional, non-carbon-based topological insulator.

For example, a single crystal layer of the at least one non-carbon-based topological insulator can have a thermal conductivity less than or equal to 1,000 Watts per meter-degree Kelvin (“W/(m-K)”) at 300 K, less than or equal to 500 W/(m-K) at 300 K, less than or equal to 250 W/(m-K) at 300 K, less than or equal to 100 W/(m-K) at 300 K, less than or equal to 50 W/(m-K) at 300 K, less than or equal to 25 W/(m-K) at 300 K, less than or equal to 10 W/(m-K) at 300 K, or less than or equal to 5 W/(m-K) at 300 K. One or more dopants can be used to tune the at least one non-carbon-based topological insulator in order to achieve these levels of thermal conductivity, as understood by one of ordinary skill in the art.

In another example, a single crystal layer of the at least one non-carbon-based topological insulator can have a thermal conductivity greater than or equal to 1 W/(m-K) at 300 K and less than or equal to 10 W/(m-K) at 300 K, greater than or equal to 10 W/(m-K) at 300 K and less than or equal to 50 W/(m-K) at 300 K, greater than or equal to 50 W/(m-K) at 300 K and less than or equal to 100 W/(m-K) at 300 K, greater than or equal to 100 W/(m-K) at 300 K and less than or equal to 250 W/(m-K) at 300 K, greater than or equal to 250 W/(m-K) at 300 K and less than or equal to 500 W/(m-K) at 300 K, or greater than or equal to 500 W/(m-K) at 300 K and less than or equal to 1,000 W/(m-K) at 300 K. One or more dopants can be used to tune the at least one non-carbon-based topological insulator in order to achieve these levels of thermal conductivity, as understood by one of ordinary skill in the art.

The at least one non-carbon-based topological insulator can have selected electrical conductivity.

As used herein, the term “electrical conductivity” means the ability to transfer electricity through a substance, mixture, or material.

The selected electrical conductivity can provide improved electrical properties, such as enhanced fire resistance, improved control over energy dissipation, and/or improved control over energy retention. Electrical conductivity has a direct physical tie to thermal conductivity, which can control energy dissipation and/or retention. With better control over electrical conductivity, static charges can be better regulated, leading to better fire resistance.

In some examples, the at least one non-carbon-based topological insulator with the selected electrical conductivity can comprise at least one two-dimensional, non-carbon-based topological insulator (the selected electrical conductivity being along edges of the 2D material). In some examples, the at least one non-carbon-based topological insulator with the selected electrical conductivity can comprise at least one three-dimensional, non-carbon-based topological insulator (the selected electrical conductivity being along surfaces of the 3D material).

For example, a single crystal layer of the at least one non-carbon-based topological insulator can have an electrical conductivity greater than or equal to 5×10³ S/m at 300 K and less than or equal to 5×10⁷ S/m at 300 K, greater than or equal to 1×10⁴ S/m at 300 K and less than or equal to 1×10⁷ S/m at 300 K, greater than or equal to 5×10⁴ S/m at 300 K and less than or equal to 5×10⁶ S/m at 300 K, or greater than or equal to 1×10⁵ S/m at 300 K and less than or equal to 1×10⁶ S/m at 300 K. One or more dopants can be used to tune the at least one non-carbon-based topological insulator in order to achieve these levels of electrical conductivity, as understood by one of ordinary skill in the art. In some examples, lower electrical conductivity can improve the insulative nature of the at least one non-carbon-based topological insulator. In some examples, higher electrical conductivity can improve the ability to transmit electrical signals through the at least one non-carbon-based topological insulator.

In another example, a single crystal layer of the at least one non-carbon-based topological insulator can have an electrical conductivity greater than or equal to 5×10³ S/m at 300 K and less than or equal to 5×10⁴ S/m at 300 K, greater than or equal to 1×10⁴ S/m at 300 K and less than or equal to 1×10⁵ S/m at 300 K, greater than or equal to 5×10⁴ S/m at 300 K and less than or equal to 5×10⁵ S/m at 300 K, greater than or equal to 1×10⁵ S/m at 300 K and less than or equal to 1×10⁶ S/m at 300 K, greater than or equal to 5×10⁵ S/m at 300 K and less than or equal to 5×10⁶ S/m at 300 K, greater than or equal to 1×10⁶ S/m at 300 K and less than or equal to 1×10⁷ S/m at 300 K, or greater than or equal to 5×10⁶ S/m at 300 K and less than or equal to 5×10⁷ S/m at 300 K. One or more dopants can be used to tune the at least one non-carbon-based topological insulator in order to achieve these levels of electrical conductivity, as understood by one of ordinary skill in the art.

The at least one non-carbon-based topological insulator can have selected electrical resistivity.

As used herein, the term “electrical resistivity” means resistance to the transfer of electricity through a substance, mixture, or material.

The selected electrical resistivity can provide improved electrical properties, such as enhanced fire resistance, improved control over energy dissipation, and/or improved control over energy retention. In some examples, lower electrical resistivity can improve the ability to transmit electrical signals through the at least one non-carbon-based topological insulator. In some examples, higher electrical resistivity can improve the insulative nature of the at least one non-carbon-based topological insulator.

In some examples, the at least one non-carbon-based topological insulator with the selected electrical resistivity can comprise at least one two-dimensional, non-carbon-based topological insulator (the selected electrical resistivity being between edges of the 2D material). In some examples, the at least one non-carbon-based topological insulator with the selected electrical resistivity can comprise at least one three-dimensional, non-carbon-based topological insulator (the selected electrical resistivity being between surfaces of the 3D material).

For example, the at least one non-carbon-based topological insulator can have an electrical resistivity greater than or equal to 1×10⁻⁵ Ω-m at 300 K and less than or equal to 1 Ω-m at 300 K, greater than or equal to 5×10⁻⁵ Ω-m at 300 K and less than or equal to 5×10⁻¹ Ω-m at 300 K, greater than or equal to 1×10⁻⁴ Ω-m at 300 K and less than or equal to 1×10⁻¹ Ω-m at 300 K, greater than or equal to 5×10⁻⁴ Ω-m at 300 K and less than or equal to 5×10⁻² Ω-m at 300 K, or greater than or equal to 1×10⁻³ Ω-m at 300 K and less than or equal to 1×10⁻² Ω-m at 300 K. One or more dopants can be used to tune the at least one non-carbon-based topological insulator in order to achieve these levels of electrical resistivity, as understood by one of ordinary skill in the art.

In another example, the at least one non-carbon-based topological insulator can have an electrical resistivity greater than or equal to 1×10⁻⁵ Ω-m at 300 K and less than or equal to 1×10⁻⁴ Ω-m at 300 K, greater than or equal to 5×10⁻⁵ Ω-m at 300 K and less than or equal to 5×10⁻⁴ Ω-m at 300 K, greater than or equal to 1×10⁻⁴ Ω-m at 300 K and less than or equal to 1×10⁻³ Ω-m at 300 K, greater than or equal to 5×10⁻⁴ Ω-m at 300 K and less than or equal to 5×10⁻³ Ω-m at 300 K, greater than or equal to 1×10⁻³ Ω-m at 300 K and less than or equal to 1×10⁻² Ω-m at 300 K, greater than or equal to 5×10⁻³ Ω-m at 300 K and less than or equal to 5×10⁻² Ω-m at 300 K, greater than or equal to 1×10⁻² Ω-m at 300 K and less than or equal to 1×10⁻¹ Ω-m at 300 K, greater than or equal to 5×10⁻² Ω-m at 300 K and less than or equal to 5×10⁻¹ Ω-m at 300 K, or greater than or equal to 1×10⁻¹ Ω-m at 300 K and less than or equal to 1 Ω-m at 300 K. One or more dopants can be used to tune the at least one non-carbon-based topological insulator in order to achieve these levels of electrical resistivity, as understood by one of ordinary skill in the art.

The preparing of the substrate surface with adherent characteristics can comprise selecting a substrate surface that is inherently attractive with respect to the at least one non-carbon-based topological insulator. Such inherent attractiveness may be based, for example, on intermolecular forces (e.g., dipole forces, van der Waals forces).

Any substrate surface not inconsistent with the present application can be used. In some examples, the substrate surface can comprise one or more of glass, metal, plastic, or semiconductor. In some examples, the substrate surface can comprise composite material, such as fiberglass composite. In some examples, the substrate surface can comprise a coated surface, including a surface coated with previously applied coating(s) or layer(s) of the at least one non-carbon-based topological insulator or one or more other topological insulators. In some examples, the substrate surface can be substantially flat or planar. In some examples, the substrate surface can be curved. In some examples, such a curved surface can be concave, convex, or include one or more concave, convex, or concave and convex portions (e.g., saddle-shaped).

In some examples, the substrate surface can comprise a surface of a window or windshield. In some examples, the substrate surface can comprise a surface of an electronic or optical component. In some examples, the substrate surface can comprise an exterior surface of a vehicle, such as an aircraft (e.g., airplane, airship, blimp, dirigible, glider, helicopter, hot-air balloon), land vehicle (e.g., automobile, bus, monorail, tank, train, truck), or watercraft (e.g., amphibian, boat, landing craft, ship, submarine, or submersible). In some examples, the at least one non-carbon-based topological insulator can be applied to the exterior surface of such a vehicle.

The preparing of the substrate surface with adherent characteristics can comprise applying charge of a second polarity, different in sign relative to the first polarity, to the substrate surface. In such examples, the total force between the charged at least one non-carbon-based topological insulator and the charged substrate surface includes, for example, electrostatic forces and intermolecular forces (e.g., dipole forces, van der Waals forces).

In some examples, the first polarity can be positive and the second polarity can be negative (i.e., opposite in sign relative to the first polarity) or ground. In some examples, the first polarity can be negative and the second polarity can be positive (i.e., opposite in sign relative to the first polarity) or ground. The material of the substrate surface can prove advantageous for a positive polarity or for a negative polarity.

The technology used to apply the charge of the first polarity to the at least one non-carbon-based topological insulator (e.g., corona gun, tribo gun, electrostatic fluidized bed, electrostatic magnetic brush) may influence the selection of a technology for applying the charge of the second polarity to the substrate surface. The charge of the second polarity can be applied to the substrate surface, for example, by electrically connecting a direct current (“DC”) voltage to the substrate surface or by electrically grounding the substrate surface, as understood by one of ordinary skill in the art.

The charged at least one non-carbon-based topological insulator can be applied to the substrate surface with adherent characteristics to provide a topological insulator layer on the substrate surface.

The charged at least one non-carbon-based topological insulator can be applied to the substrate surface in any manner not inconsistent with the present application. In some examples, the charged at least one non-carbon-based topological insulator can be sprayed onto the substrate surface. In some examples, the charged at least one non-carbon-based topological insulator can be brushed, daubed, or rolled onto the substrate surface. In some examples, the substrate surface can be dipped into the charged at least one non-carbon-based topological insulator.

A topological insulator layer can have any thickness not inconsistent with the present application.

In some examples, the topological insulator layer can have an average thickness of about 1 nm, about 2 nm, about 3 nm, about 4 nm, about 5 nm, about 6 nm, about 7 nm, about 8 nm, about 9 nm, or about 10 nm. In some examples, the topological insulator layer can have an average thickness of up to about 10 nm, up to about 20 nm, up to about 30 nm, up to about 40 nm, or up to about 50 nm. In some examples, the topological insulator layer can have an average thickness of up to about 100 nm, up to about 200 nm, up to about 300 nm, up to about 400 nm, or up to about 500 nm. The thickness, to first order, affects the strength of the topological insulator layer. And through tuning, you can create a band structure that is a hybrid of a 2D-structure and a 3D-structure, so that you have macroscopic physical properties that affect electrical conductivity, electrical resistivity, optical transmittance, and/or thermal conductivity.

As used herein, the term “up to”, when used in connection with an amount or quantity, means that the amount is at least a detectable amount or quantity (e.g., “up to about 1 mm” means at least a detectable amount and less than or equal to about 1 millimeter).

In some examples, the topological insulator layer can have an average thickness of up to about 1 micron (“μm”), up to about 2 μm, up to about 3 μm, up to about 4 μm, or up to about 5 μm. In some examples, the topological insulator layer can have an average thickness of up to about 10 μm, up to about 20 μm, up to about 30 μm, up to about 40 μm, or up to about 50 μm. In some examples, the topological insulator layer can have an average thickness of up to about 100 μm, up to about 200 μm, up to about 300 μm, up to about 400 μm, or up to about 500 μm.

In some examples, the topological insulator layer can have an average thickness of up to about 1 millimeter (“mm”), up to about 2 mm, up to about 3 mm, up to about 4 mm, or up to about 5 mm. In some examples, the topological insulator layer can have an average thickness greater than or equal to about 1 mm and less than or equal to about 5 mm.

In some examples, the topological insulator layer can have an average thickness greater than or equal to about 1 nm and less than or equal to about 10 nm. In some examples, the topological insulator layer can have an average thickness greater than or equal to about 10 nm and less than or equal to about 100 nm. In some examples, the topological insulator layer can have an average thickness greater than or equal to about 100 nm and less than or equal to about 1,000 nm.

In some examples, the topological insulator layer can have an average thickness greater than or equal to about 1 μm and less than or equal to about 10 μm. In some examples, the topological insulator layer can have an average thickness greater than or equal to about 10 μm and less than or equal to about 100 μm. In some examples, the topological insulator layer can have an average thickness greater than or equal to about 100 μm and less than or equal to about 1,000 μm. In some examples, the topological insulator layer can have an average thickness greater than or equal to about 1 mm and less than or equal to about 5 mm.

Applying of the charged at least one non-carbon-based topological insulator to the substrate surface with adherent characteristics can be repeated a desired number of times to provide a thicker topological insulator layer.

A topological insulator layer formed by applying a charged at least one non-carbon-based topological insulator to a substrate surface with adherent characteristics can have any chemical property, morphology, or thickness not inconsistent with the present application. The topological insulator layer comprises, consists essentially of, or consists of the at least one non-carbon-based topological insulator.

In some examples, a topological insulator layer can comprise greater than or equal to about 50 atom percent, greater than or equal to about 60 atom percent, greater than or equal to about 70 atom percent, greater than or equal to about 80 atom percent, greater than or equal to about 90 atom percent, greater than or equal to about 95 atom percent, greater than or equal to about 98 atom percent, or greater than or equal to about 99 atom percent of the at least one non-carbon-based topological insulator.

In some examples, the topological insulator layer can comprise greater than or equal to about 50% by weight of the at least one non-carbon-based topological insulator, greater than or equal to about 60% by weight of the at least one non-carbon-based topological insulator, greater than or equal to about 70% by weight of the at least one non-carbon-based topological insulator, greater than or equal to about 75% by weight of the at least one non-carbon-based topological insulator, greater than or equal to about 80% by weight of the at least one non-carbon-based topological insulator, greater than or equal to about 85% by weight of the at least one non-carbon-based topological insulator, greater than or equal to about 90% by weight of the at least one non-carbon-based topological insulator, or greater than or equal to about 95% by weight of the at least one non-carbon-based topological insulator.

A topological insulator layer can comprise any number of molecular layers of the at least one non-carbon-based topological insulator not inconsistent with the present application. In some examples, the topological insulator layer can comprise, consists essentially of, or consist of a single molecular layer of the at least one non-carbon-based topological insulator. In some examples, the single molecular layer can have a flat, planar structure. In some examples, the topological insulator layer can comprise, consists essentially of, or consist of multiple molecular layers of the at least one non-carbon-based topological insulator. In some examples, the multiple molecular layers can have a flat, planar structure.

In some examples, the topological insulator layer can comprise, consists essentially of, or consist of greater than or equal to 1 and less than or equal to about 10 molecular layers of the at least one non-carbon-based topological insulator. In some examples, the topological insulator layer can comprise, consists essentially of, or consist of greater than or equal to about 10 and less than or equal to about 100 molecular layers of the at least one non-carbon-based topological insulator. In some examples, the topological insulator layer can comprise, consists essentially of, or consist of greater than or equal to about 100 and less than or equal to about 1,000 molecular layers of the at least one non-carbon-based topological insulator insulator.

In some examples, the topological insulator layer can comprise, consists essentially of, or consist of a sufficient number of molecular layers of the at least one non-carbon-based topological insulator to provide a layer thickness of up to about 1 μm, up to about 10 μm, up to about 100 μm, up to about 1 mm, or up to about 5 mm.

In some examples, a topological insulator layer can be continuous or substantially continuous across the substrate surface with adherent characteristics, as opposed to being discontinuous or unevenly disposed on such a surface. In some examples, a substantially continuous layer can cover at least about 90 percent, at least about 95 percent, or at least about 99 percent of the substrate surface with adherent characteristics.

For example, a topological insulator layer can cover a substrate area greater than about 0.0001 square meters (“m²”), greater than about 0.001 m², greater than about 0.01 m², greater than about 0.1 m², greater than about 1 m², greater than about 10 m², greater than about 100 m², greater than about 1,000 m², or greater than about 10,000 m², including in continuous or substantially continuous manner.

In another example, a topological insulator layer can cover a substrate area greater than about 0.0001 m² and less than about 0.001 m², greater than about 0.001 m² and less than about 0.01 m², greater than about 0.01 m² and less than about 0.1 m², greater than about 0.1 m² and less than about 1 m², greater than about 1 m² and less than about 10 m², greater than about 10 m² and less than about 100 m², greater than about 100 m² and less than about 1,000 m², greater than about 1,000 m² and less than about 10,000 m², including in continuous or substantially continuous manner.

A topological insulator layer can have a uniform or substantially uniform thickness across the across the substrate surface with adherent characteristics. A substantially uniform thickness can comprise vary by less than about 20 percent, by less than about 10 percent, or by less than about 5 percent, based on the average thickness of the topological insulator layer.

The thickness of a topological insulator layer can be selected by varying one or more parameters during deposition of the topological insulator layer on a substrate surface with adherent characteristics. The thickness of the topological insulator layer can be selected by varying the number of times or the force with which a source of the at least one non-carbon-based topological insulator is applied to or rolled across the surface, where the application of more force and/or repeated application of the source of the at least one non-carbon-based topological insulator can provide a thicker topological insulator layer. An applied force or number of repetitions can be selected using information obtained from a detector configured to determine the thickness of the topological insulator layer or coating deposited on the surface. The information can be obtained in real-time by providing information regarding the output of the detector (e.g., a measured electrical conductivity change) to an apparatus used to deposit the topological insulator layer.

Any detector not inconsistent with the present application can be used. For example, the detector can comprise an acoustic wave detector configured to determine thickness of the topological insulator layer. In some examples, the detector can be configured to determine the thickness of the topological insulator layer by measuring optical transmittance of the topological insulator layer. In some examples, the detector can be configured to determine thermal conductivity of the topological insulator layer. In some examples, the detector can be configured to determine electrical conductivity of the topological insulator layer. In some examples, the detector can be configured to determine electrical resistivity of the topological insulator layer.

Comparison of a measured acoustic wave value, optical transmittance value, thermal conductivity value, electrical conductivity value, or electrical resistivity value with a theoretical value for the topological insulator layer of a specified thickness can, in some examples, permit a user to determine the thickness of the topological insulator layer. In some examples, a measured optical transmittance value for a multiple-layer thickness of the at least one non-carbon-based topological insulator will be, to first order, a multiple of a measured optical transmittance value for a single-layer thickness.

The method of forming the coating can further comprise: applying a topological insulator remover to the topological insulator layer to remove some, but not all, of the topological insulator layer to provide a final coating. Applying the topological insulator remover to the topological insulator layer can comprise rolling an adhesive roller over the topological insulator layer to remove some, but not all, of the topological insulator layer to provide the final coating. The final coating can have a lower average thickness than the topological insulator layer.

In some examples, no topological insulator remover may be applied to the topological insulator layer. Thus, the topological insulator layer can serve as the final coating.

The applying of the topological insulator remover to the topological insulator layer to remove some, but not all, of the topological insulator layer to provide the final coating can comprise applying the topological insulator remover in any manner not inconsistent with the present application. The topological insulator remover can be blotted, daubed, pressed, rolled, or rubbed on the topological insulator layer.

The topological insulator remover can comprise any apparatus not inconsistent with the present application. In some examples, the topological insulator remover can comprise one or more planar surfaces that provide abrasion, adhesion, and/or friction to the topological insulator layer. In some examples, the topological insulator remover can comprise one or more curved surfaces in addition to or instead of the one or more planar surfaces. In some examples, applying the topological insulator remover to a topological insulator layer can comprise rolling an adhesive roller over the topological insulator layer. Any adhesive roller not inconsistent with the present application can be used. In some examples, the adhesive roller can comprise an adhesive material on a rolling surface of the adhesive roller.

In some examples, a curved, planar, or rolling surface of a topological insulator remover (e.g., adhesive roller) can have any shape, size, and/or morphology not inconsistent with the present application. In some examples, the curved, planar, or rolling surface of the topological insulator remover can have the same shape, size, and/or morphology as the source of the at least one non-carbon-based topological insulator. In some examples, the curved or rolling surface of the topological insulator remover can be relatively flexible or stiff, and/or can be shaped as concave or convex. In some examples, the curved or rolling surface of the topological insulator remover can have the shape of a convex lens (e.g., a prolate or oblate spheroid). In some examples, the curved, planar, or rolling surface of the topological insulator remover can be relatively flexible or stiff, and/or can be shaped as a right circular cylinder. In some examples, the curved, planar, or rolling surface of the topological insulator remover can be selected based on the morphology of the substrate surface and/or topological insulator layer.

The topological insulator remover can comprise a rod comprising an adhesive roller. The rod can have any size and shape not inconsistent with the present application. In some examples, the rod can have a cylindrical or substantially cylindrical shape. In some examples, the rod can have a prolate or oblate spheroid shape. In some examples, the rod can have a diamond-like shape.

In some examples, the rod can have a concave or convex surface. In some examples, a rod having a concave surface can be used to remove some, but not all, of a topological insulator layer from a convex substrate surface with adherent characteristics by, for example, rolling the adhesive roller over the topological insulator layer. In some examples, a rod having a convex surface can be used to remove some, but not all, of a topological insulator layer from a concave substrate surface with adherent characteristics by, for example, rolling the adhesive roller over the topological insulator layer. Thus, as understood by one of ordinary skill in the art, the size and shape of the rod can be selected based on the morphology of the surface and/or topological insulator layer.

The rod can can a tubular morphology. For example, the rod can have a drilled-out or hollow center. Such a tubular rod can be more easily coupled to a handle, holder, or other apparatus for rolling the tubular rod over the surface and/or topological insulator layer.

The rod can have a spherical morphology. Such a sphere can have a drilled-out or hollow center in order to provide a spherical “stringed bead” morphology for coupling to a handle, holder, or other apparatus for rolling the spherical “stringed bead” over the surface and/or topological insulator layer.

The thickness of a topological insulator layer can be selected by varying one or more parameters during removal of some, but not all, of the topological insulator layer. In some examples, the thickness of the topological insulator layer can be selected by varying the number of times or the force with which a topological insulator remover (e.g., adhesive roller) is rolled across the surface, where the application of more force and/or repeated application of the topological insulator remover can provide a thinner topological insulator layer. In some examples, an applied force or number of repetitions can be selected using information obtained from a detector configured to determine the thickness of the topological insulator layer or coating remaining on the surface. In some examples, the information can be obtained in real-time by providing information regarding the output of the detector (e.g., a measured electrical conductivity change) to an apparatus used to remove some, but not all, of the topological insulator layer.

Any detector not inconsistent with the present application can be used. For example, the detector can comprise an acoustic wave detector configured to determine thickness of the topological insulator layer. The detector can be configured to determine the thickness of the topological insulator layer by measuring optical transmittance of the topological insulator layer. The detector can be configured to determine thermal conductivity of the topological insulator layer. The detector can be configured to determine electrical conductivity of the topological insulator layer. The detector can be configured to determine electrical resistivity of the topological insulator layer.

Comparison of a measured acoustic wave value, optical transmittance value, thermal conductivity value, electrical conductivity value, or electrical resistivity value with a theoretical value for the topological insulator layer of a specified thickness can permit a user to determine the thickness of the topological insulator layer.

The topological insulator remover can comprise an apparatus comprising a handle and a rod or sphere comprising, for example, an adhesive roller attached to the handle, wherein the rod or sphere is configured to roll or otherwise move when the handle is moved in a direction tangential to a surface of the rod or sphere, such as a curved surface of the rod or sphere. In some examples, the handle can be gripped and operated manually by a user. In some examples, the apparatus can further comprise a moveable support structure, the handle being attached to the moveable support structure. Such a moveable support structure can be a mechanized or robotic support structure, thus providing automated removal of some, but not all, of a topological insulator layer.

The adhesive roller can comprise adhesive material. Any adhesive material not inconsistent with the present application can be used as the adhesive material. The adhesive material can be, for example, a fluid material or a solid material. In some examples, the adhesive material can comprise an animal protein-based adhesive material, such as albumin glue, casein glue, collagen glue, meat glue, or a combination thereof. In some examples, the adhesive material can comprise bone glue, fish glue, hide glue, hoof glue, rabbit skin glue, or a combination thereof. In some examples, the adhesive material can comprise plant-based adhesive material, such as resin, starch, or a combination thereof. In some examples, the adhesive material can comprise Canada balsam resin, coccoina, gum arabic resin, latex, methyl cellulose, mucilage, resorcinol resin, urea-formaldehyde resin, or a combination thereof. The adhesive material also can comprise synthetic adhesive material, such as synthetic monomer glue, synthetic polymer glue, or a combination thereof. In some examples, the adhesive material can comprise acrylic glue, acrylonitrile, cyanoacrylate, or a combination thereof. In some examples, the adhesive material can comprise epoxy putty, epoxy resin, ethylene-vinyl acetate, phenol formaldehyde resin, polyamide, polyester resin, polyethylene hot-melt glue, polypropylene glue, polysulfide, polyurethane, polyvinyl acetate, polyvinyl alcohol, polyvinyl chloride, polyvinylpyrrolidone, rubber cement, silicone, styrene acrylate copolymer, or a combination thereof. In some examples, the adhesive material can comprise solvent-based adhesive. In some examples, the adhesive material can comprise wet paint or primer, partially dried paint or primer, or other coating material(s).

The adhesive material can be selected based on desired adhesion strength to the at least one non-carbon-based topological insulator. The adhesion strength of the adhesive material to the at least one non-carbon-based topological insulator can be measured in any manner not inconsistent with the present application. The adhesion strength of the adhesive material to the at least one non-carbon-based topological insulator can be measured according to ASTM International Standard D4541 and/or International Organization for Standardization (“ISO”) Standard 4624. In some examples, the adhesive material can have an adhesion strength to the at least one non-carbon-based topological insulator that is greater than, equal to, or less than the inter-sheet bonding energy of the at least one non-carbon-based topological insulator. Selecting an adhesive material having an adhesion strength that is equal to or less than the inter-sheet bonding energy, for example, can permit the removal of some, but not all, of a topological insulator layer from a substrate surface with adherent characteristics by, for example, rolling an adhesive roller over the topological insulator layer. In some examples, the methods described herein can provide simple and cost-effective methods of forming a coating that comprises the at least one non-carbon-based topological insulator, including over large areas.

The adhesion strength of the adhesive material to the at least one non-carbon-based topological insulator can be greater than, equal to, or less than the adhesion strength of the at least one non-carbon-based topological insulator to the substrate surface.

The adhesion strength of the adhesive material to the at least one non-carbon-based topological insulator can be less than or equal to the adhesion strength of the at least one non-carbon-based topological insulator to the substrate surface. Selecting an adhesive material having such an adhesion strength can permit the removal of some, but not all, of a topological insulator layer from a substrate surface with adherent characteristics by, for example, rolling an adhesive roller over the topological insulator layer. The methods described herein can provide simple and cost-effective methods of forming a coating that comprises the at least one non-carbon-based topological insulator, including over large areas.

In some examples, a ratio of the adhesion strength of the adhesive material to the at least one non-carbon-based topological insulator to the adhesion strength of the at least one non-carbon-based topological insulator to the substrate surface can be greater than or equal to 0.1:1 and less than or equal to 1:1. In some examples, the ratio of the adhesion strength of the adhesive material to the at least one non-carbon-based topological insulator to the adhesion strength of the at least one non-carbon-based topological insulator to the substrate surface can be greater than or equal to 0.1:1, greater than or equal to 0.3:1, greater than or equal to 0.5:1, greater than or equal to 0.7:1, or greater than or equal to 0.9:1.

In some examples, a ratio of the adhesion strength of the adhesive material to the at least one non-carbon-based topological insulator to the adhesion strength of the at least one non-carbon-based topological insulator to the substrate surface can be greater than or equal to 0.1:1 and less than 1:1. In some examples, the ratio of the adhesion strength of the adhesive material to the at least one non-carbon-based topological insulator to the adhesion strength of the at least one non-carbon-based topological insulator to the substrate surface can be greater than or equal to about 0.2:1 and less than or equal to about 0.4:1, greater than or equal to about 0.4:1 and less than or equal to about 0.6:1, greater than or equal to about 0.6:1 and less than or equal to about 0.8:1, or greater than or equal to about 0.8:1 and less than or equal to about 0.99:1. In some examples, the ratio of the adhesion strength of the adhesive material to the at least one non-carbon-based topological insulator to the adhesion strength of the at least one non-carbon-based topological insulator to the substrate surface can be greater than or equal to about 0.1:1 and less than or equal to about 0.5:1, greater than or equal to about 0.3:1 and less than or equal to about 0.7:1, greater than or equal to about 0.5:1 and less than or equal to about 0.9:1, or greater than or equal to about 0.7:1 and less than or equal to about 0.99:1.

A final coating can have any thickness not inconsistent with the present application. The thickness of the topological insulator layer can be selected by varying one or more parameters during deposition of the topological insulator layer. For example, a user can vary the number of times with which a source of the at least one non-carbon-based topological insulator is applied to the substrate surface with adherent characteristics or the force with which the source of the at least one non-carbon-based topological insulator is applied to or rolled over the substrate surface with adherent characteristics.

In some examples, the final coating can have an average thickness of about 1 nm, about 2 nm, about 3 nm, about 4 nm, about 5 nm, about 6 nm, about 7 nm, about 8 nm, about 9 nm, or about 10 nm. In some examples, the final coating can have an average thickness of up to about 10 nm, up to about 20 nm, up to about 30 nm, up to about 40 nm, up to about 50 nm, up to about 60 nm, up to about 70 nm, up to about 80 nm, up to about 90 nm, or about 100 nm. In some examples, the final coating can have an average thickness of up to about 100 nm, up to about 200 nm, up to about 300 nm, up to about 400 nm, up to about 500 nm, up to about 600 nm, up to about 700 nm, up to about 800 nm, up to about 900 nm, or about 1,000 nm. The thickness, to first order, affects the strength of the final coating.

In some examples, the final coating can have an average thickness of up to about 1 μm, up to about 2 μm, up to about 3 μm, up to about 4 μm, up to about 5 μm, up to about 6 μm, up to about 7 μm, up to about 8 μm, up to about 9 μm, or about 10 μm. In some examples, the final coating can have an average thickness of up to about 10 μm, up to about 20 μm, up to about 30 μm, up to about 40 μm, up to about 50 μm, up to about 60 μm, up to about 70 μm, up to about 80 μm, up to about 90 μm, or about 100 μm. In some examples, the final coating can have an average thickness of up to about 100 μm, up to about 200 μm, up to about 300 μm, up to about 400 μm, up to about 500 μm, up to about 600 μm, up to about 700 μm, up to about 800 μm, up to about 900 μm, or about 1,000 μm.

In some examples, the final coating can have an average thickness of up to about 1 millimeter (“mm”), up to about 2 mm, up to about 3 mm, up to about 4 mm, or up to about 5 mm. In some examples, the final coating can have an average thickness greater than or equal to about 1 mm and less than or equal to about 5 mm.

In some examples, the final coating can have an average thickness greater than or equal to about 1 nm and less than or equal to about 10 nm. In some examples, the final coating can have an average thickness greater than or equal to about 10 nm and less than or equal to about 100 nm. In some examples, the final coating can have an average thickness greater than or equal to about 100 nm and less than or equal to about 1,000 nm.

In some examples, the final coating can have an average thickness greater than or equal to about 1 μm and less than or equal to about 10 μm. In some examples, the final coating can have an average thickness greater than or equal to about 10 μm and less than or equal to about 100 μm. In some examples, the final coating can have an average thickness greater than or equal to about 100 μm and less than or equal to about 1,000 μm. In some examples, the final coating can have an average thickness greater than or equal to about 1 mm and less than or equal to about 5 mm.

The final coating can include an outer coating, such as a polymer coating. The polymer coating can provide protection from the environment (e.g., ultraviolet radiation); can improve electrical, mechanical, or optical properties; can enhance chemical resistance, corrosion resistance, fire resistance, or fire retardancy; can provide hydrophilic or hydrophobic characteristics; can reduce drag and/or friction; and/or can promote laminar flow of a fluid (e.g., air, water) over the outer coating.

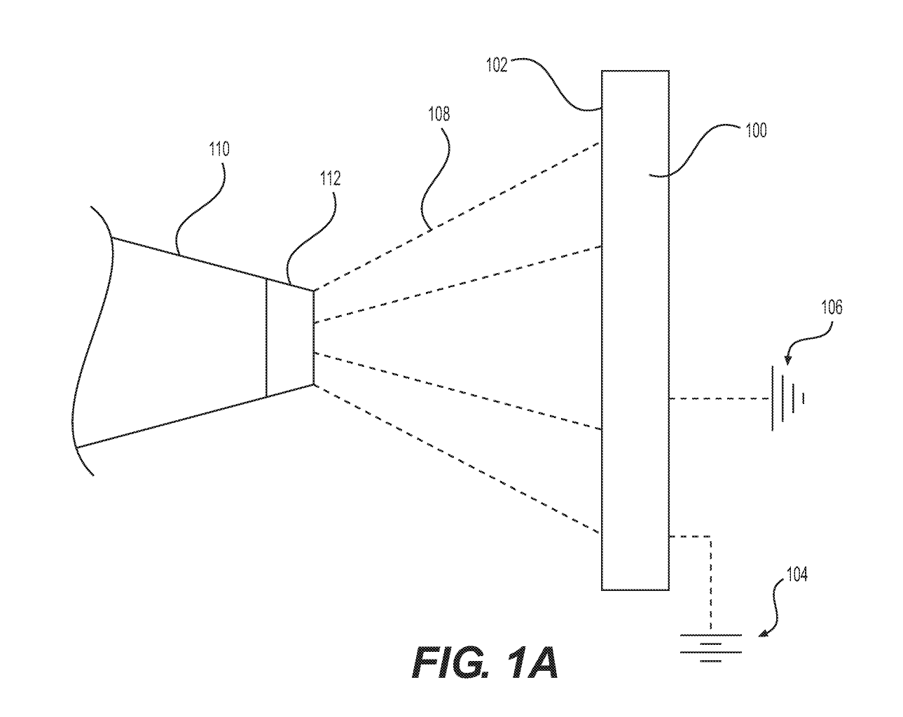

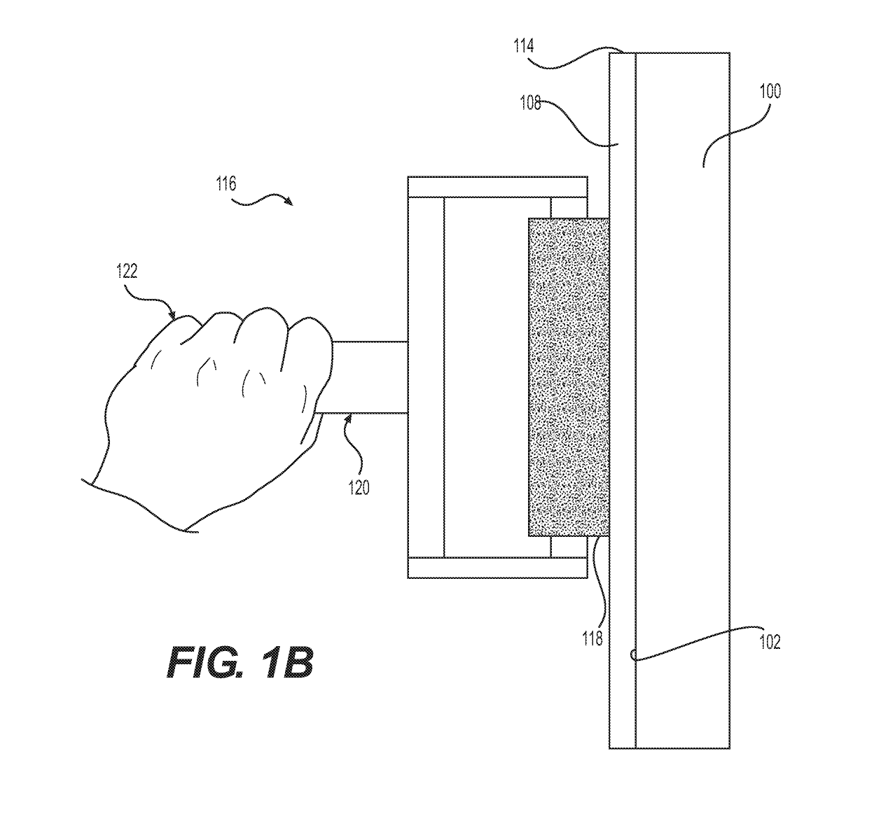

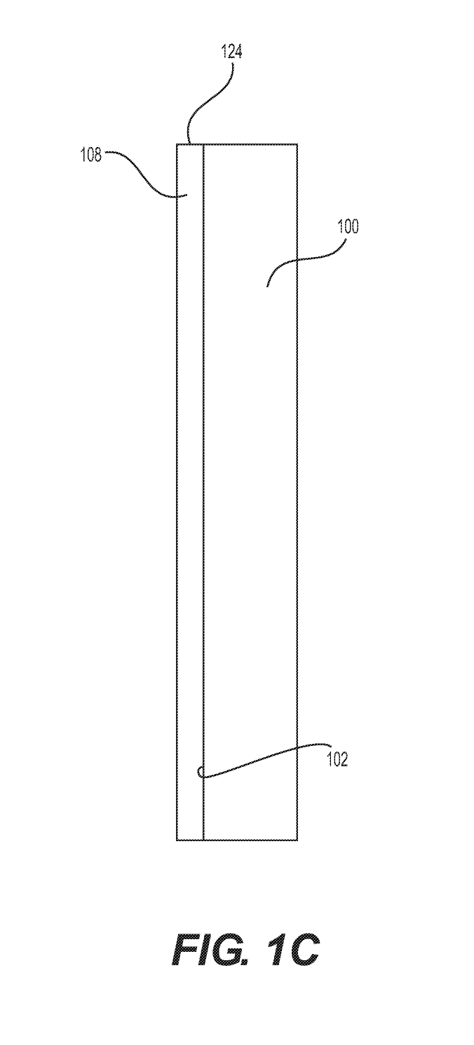

FIGS. 1A-1C show sectional views of components involved in a method of and/or a system for forming a coating, according to some examples of the disclosed methods and systems. As shown in FIG. 1A, substrate 100 has surface 102. Surface 102 can be prepared with adherent characteristics.

For example, the preparing of surface 102 with adherent characteristics can comprise selecting substrate 100 that is inherently attractive with respect to the at least one non-carbon-based topological insulator. The adherent characteristics of surface 102 can be improved, for example, by roughening surface 102, by treating surface 102 with one or more chemicals, and/or by other processes understood by one of ordinary skill in the art.

In another example, the preparing of surface 102 with adherent characteristics can comprise applying charge of a second polarity, different in sign relative to the first polarity, to surface 102 of substrate 100. As shown in FIG. 1A, voltage 104 (e.g., DC) optionally can be electrically connected to substrate 100. The polarity of voltage 104 can be opposite to that of the first polarity (e.g., if the first polarity is negative, voltage 104 can be positive; if the first polarity is positive, voltage 104 can be negative). In the alternative, substrate 100 optionally can be connected to electrical ground 106.

As shown in FIG. 1A, at least one non-carbon-based topological insulator 108 can be sprayed from nozzle 110 via electrode 112 onto surface 102. As at least one non-carbon-based topological insulator 108 passes electrode 112, electrode 112 applies charge of a first polarity to at least one non-carbon-based topological insulator 108. In some examples, the first polarity can be negative. In some examples, the first polarity can be positive.

The charge of the first polarity can be applied to at least one non-carbon-based topological insulator 108 in any manner not inconsistent with the present application (e.g., corona gun, tribo gun, electrostatic fluidized bed, electrostatic magnetic brush).

Charged at least one non-carbon-based topological insulator 108 can be applied to surface 102 in any manner not inconsistent with the present application. In some examples, charged at least one non-carbon-based topological insulator 108 can be brushed, daubed, rolled, or sprayed onto surface 102. In some examples, surface 102 and/or substrate 100 can be dipped into charged at least one non-carbon-based topological insulator 108. The bonding of charged at least one non-carbon-based topological insulator 108 to surface 102 can be improved, for example, by roughening surface 102, by treating surface 102 with one or more chemicals, and/or by other processes understood by one of ordinary skill in the art.

As shown in FIG. 1B, applying charged at least one non-carbon-based topological insulator 108 to surface 102 of substrate 100 provides topological insulator layer 114 on surface 102.

Following deposition of topological insulator layer 114, apparatus 116 comprising adhesive roller 118 optionally can be rolled over topological insulator layer 114 to remove some, but not all, of topological insulator layer 114 to provide a final coating. As shown in FIG. 1B, apparatus 116 can comprise handle 120 to which adhesive roller 118 is attached. User 122 can use apparatus 116 to manually roll adhesive roller 118 over topological insulator layer 114 to provide the final coating. However, it also can be possible to roll adhesive roller 118 over topological insulator layer 114 using, for example, an automated, mechanized, or robotic apparatus.

Although FIG. 1B depicts user 122 as a human hand, user 122 may be an end effector(s), robot(s), or the like configured to operate on and/or cooperate with handle 120.

As shown in FIG. 1C, final coating 124 can have a lower average thickness than topological insulator layer 114.

As shown in FIG. 1B, adhesive roller 118 can have a substantially cylindrical morphology. Such cylindrical morphologies, in some instances, can be especially suitable for use with a substantially flat or planar substrate surface, such as the surface of topological insulator layer 114 in FIG. 1B. However, other configurations are possible.

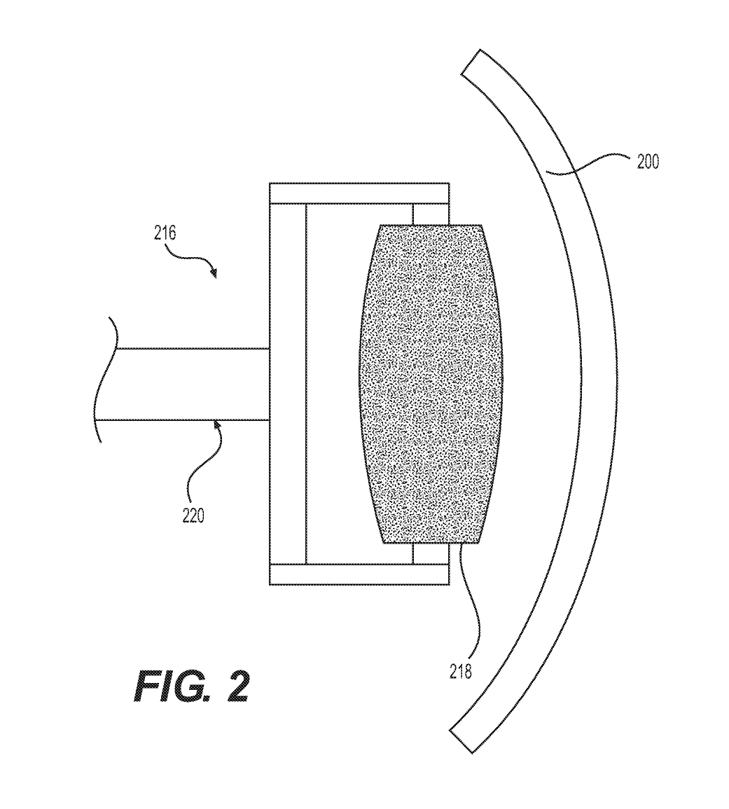

Adhesive roller 118 can be especially suitable for use with substrate surfaces that are not substantially flat or planar, as shown in FIGS. 2-5. FIGS. 2-5 show sectional views of components involved in a method of and/or a system for forming a coating, according to some examples of the disclosed methods and systems.

As shown in FIG. 2, for example, apparatus 216 can comprise handle 220, and adhesive roller 218 attached to handle 220. Adhesive roller 218 can be, for example, relatively stiff with a cross-section resembling the shape of a convex lens (e.g., a prolate or oblate spheroid), relatively flexible and shaped as a right circular cylinder, or something in between. Adhesive roller 218 can be configured to roll along a curved surface of substrate 200 when handle 220 is moved in a direction tangential to the curved surface of substrate 200, such as a direction perpendicular to the plane of the paper in FIG. 2.

As shown in FIG. 2, the curved surface of substrate 200 can be concave. Independent of stiffness/flexibility, adhesive roller 218 can be configured such that the curvature of adhesive roller 218 in contact with the curved surface of substrate 200 matches the curvature of the curved surface of substrate 200 in a complementary manner.

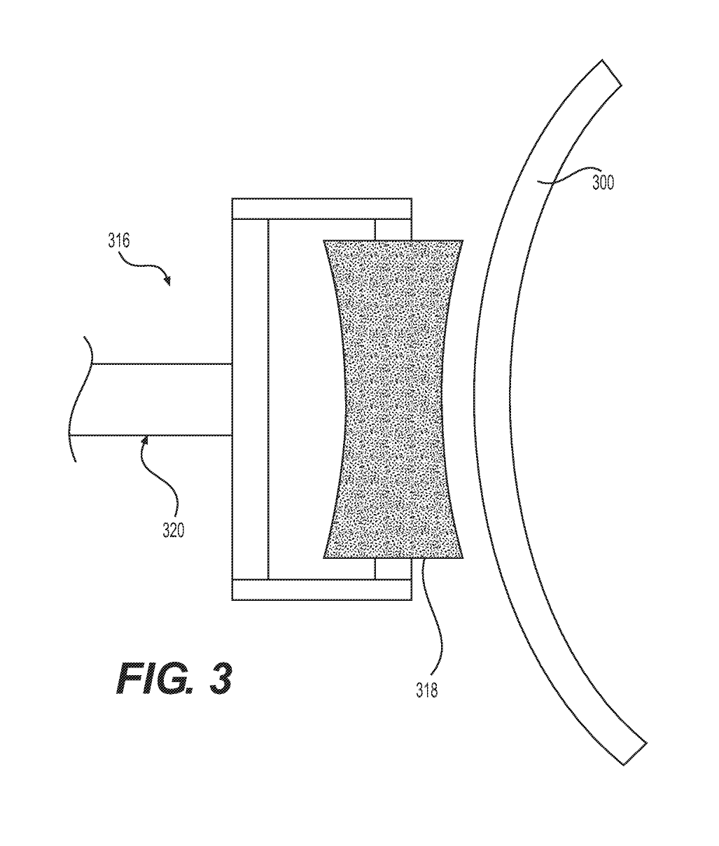

As shown in FIG. 3, for example, apparatus 316 can comprise handle 320, and adhesive roller 318 attached to handle 320. Adhesive roller 318 can be, for example, relatively stiff with a cross-section resembling the shape of a concave lens, relatively flexible and shaped as a right circular cylinder, or something in between. Adhesive roller 318 can be configured to roll along a curved surface of substrate 300 when handle 320 is moved in a direction tangential to the curved surface of substrate 300, such as a direction perpendicular to the plane of the paper in FIG. 3.

As shown in FIG. 3, the curved surface of substrate 300 can be convex. Independent of stiffness/flexibility, adhesive roller 318 can be configured such that the curvature of adhesive roller 318 in contact with the curved surface of substrate 300 matches the curvature of the curved surface of substrate 300 in a complementary manner.

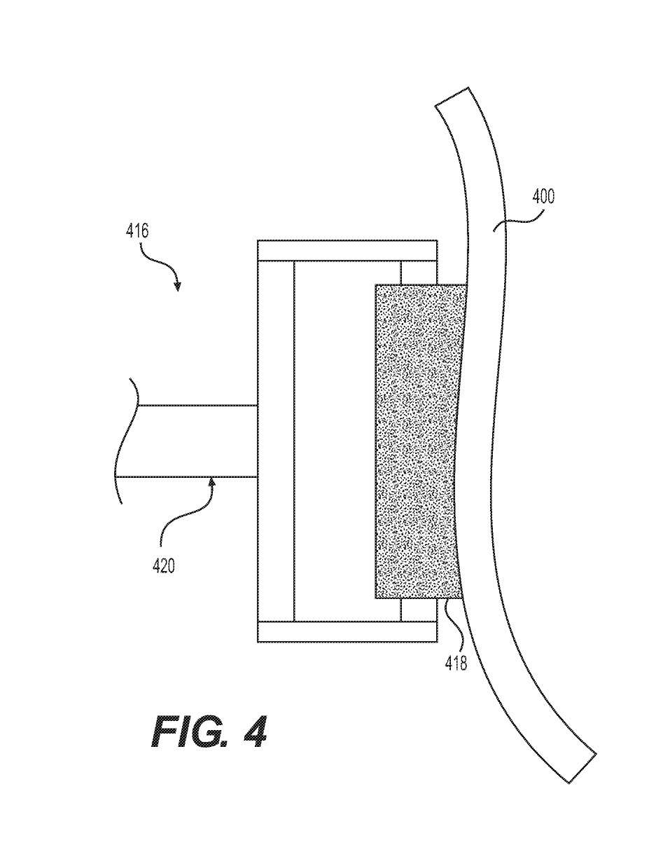

As shown in FIG. 4, for example, apparatus 416 can comprise handle 420, and adhesive roller 418 attached to handle 420. Adhesive roller 418 can be, for example, relatively flexible and shaped as a right circular cylinder. Adhesive roller 418 can be configured to roll along a curved surface of substrate 400 when handle 420 is moved in a direction tangential to the curved surface of substrate 400, such as a direction perpendicular to the plane of the paper in FIG. 4.

As shown in FIG. 4, the curved surface of substrate 400 can be complex (e.g., both concave and convex). Independent of stiffness/flexibility, adhesive roller 418 can be configured such that the curvature of adhesive roller 418 in contact with the curved surface of substrate 400 matches the curvature of the curved surface of substrate 400 in a complementary manner.

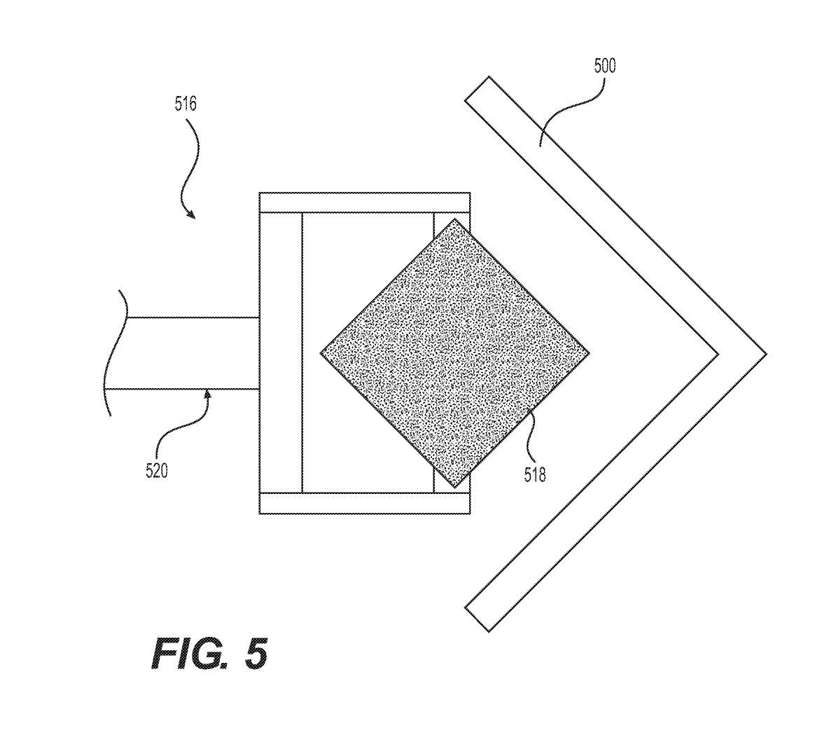

As shown in FIG. 5, for example, apparatus 516 can comprise handle 520, and adhesive roller 518 attached to handle 520. Adhesive roller 518 can be, for example, relatively stiff or relatively flexible with a cross-section resembling a diamond-like shape. Adhesive roller 518 can be configured to roll along a sharply angled surface (e.g., a corner) of substrate 500 when handle 520 is moved in a direction tangential to the curved surface of substrate 500, such as a direction perpendicular to the plane of the paper in FIG. 5.

As shown in FIG. 5, the curved surface of substrate 500 can be sharply angled. Independent of stiffness/flexibility, adhesive roller 518 can be configured such that the curvature of adhesive roller 518 in contact with the curved surface of substrate 500 matches the curvature of the curved surface of substrate 500 in a complementary manner.

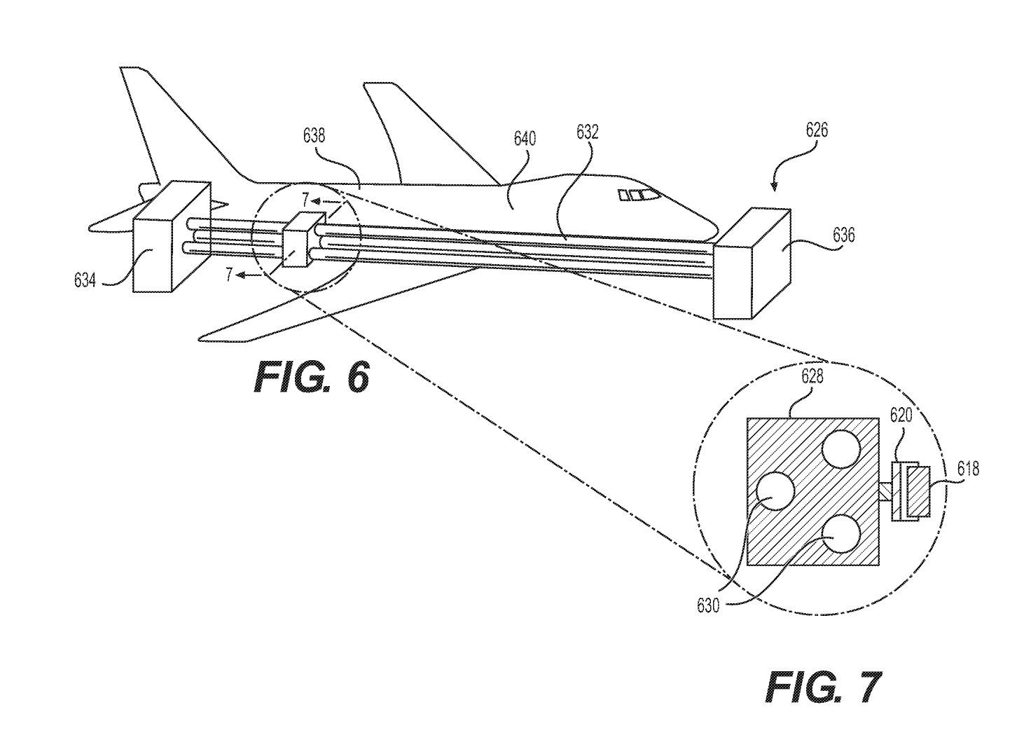

FIG. 6 shows a perspective view of components involved in a method of and/or a system for forming a coating, according to some examples of the disclosed methods and systems, while FIG. 7 shows a sectional view of components involved in a method of and/or a system for forming a coating, according to some examples of the disclosed methods and systems, taken along line 7-7 of FIG. 6. As shown in FIGS. 6 and 7, system 626 can comprise moveable support structure 628 and handle 620.

Moveable support structure 628 can comprise a track mechanism. For example, moveable support structure 628 can comprise guide rail holes 630 configured to couple to one or more guide rails 632 of system 626.

As shown in FIG. 6, one or more guide rails 632 can be between first scaffold 634 and second scaffold 636. One or more guide rails 632 can be configured to permit the movement of moveable support structure 628, handle 620, and adhesive roller 618 attached to handle 620 along the length of one or more guide rails 632.

Further, system 626 can comprise one or more motors (not shown) and a controller (not shown) configured to control and power the movement of moveable support structure 628, handle 620, and adhesive roller 618 along the length of one or more guide rails 632. By moving moveable support structure 628, handle 620, and adhesive roller 618 along the length of one or more guide rails 632 between first scaffold 634 and second scaffold 636, system 626 can provide a coating comprising at least one non-carbon-based topological insulator on a surface 638 of a large object such as an airplane 640 in a rapid, efficient, and cost-effective manner.

In some examples, an apparatus configured to apply a charged at least one non-carbon-based topological insulator to a substrate surface (e.g., surface 638) to provide a topological insulator layer on the substrate surface can be used in place of adhesive roller 618 in order to apply the charged at least one non-carbon-based topological insulator to the substrate surface, as understood by one of ordinary skill in the art.

First scaffold 634 and second scaffold 636 can be configured to move in one or more dimensions, such as in a vertical dimension or to trace a curve. First scaffold 634 and second scaffold 636 also can be equipped, for example, with a robotic arm for multi-dimensional movement.

Potential dopants for topological insulators include, for example, semiconductors, rare earth elements, transition metals, and/or other elements. Such semiconductors can include, for example, germanium (“Ge”), silicon (“Si”), and silicon-germanium alloys (e.g., Si₁₋ₓGeₓ (0<x<1)). Such rare earth elements can include, for example, cerium (“Ce”), dysprosium (“Dy”), erbium (“Er”), europium (“Eu”), gadolinium (“Gd”), holmium (“Ho”), lanthanum (“La”), lutetium (“Lu”), neodymium (“Nd”), praseodymium (“Pr”), promethium (“Pm”), samarium (“Sm”), scandium (“Sc”), terbium (“Tb”), thulium (“Tm”), ytterbium (“Yb”), and yttrium (“Y”). Such transition metals can include, for example, bohrium (“Bh”), cadmium (“Cd”), chromium (“Cr”), cobalt (“Co”), copernicium (“Cn”), copper (“Cu”), darmstadtium (“Ds”), dubnium (“Db”), gold (“Au”), hafnium (“Hf”), hassium (“Hs”), iridium (“Ir”), iron (“Fe”), manganese (“Mn”), meitnerium (“Mt”), mercury (“Hg”), molybdenum (“Mo”), nickel (“Ni”), niobium (“Nb”), osmium (“Os”), palladium (“Pd”), platinum (“Pt”), rhenium (“Re”), rhodium (“Rh”), roentgenium (“Rg”), ruthenium (“Ru”), rutherfordium (“Rf”), seaborgium (“Sg”), silver (“Ag”), tantalum (“Ta”), technetium (“Tc”), titanium (“Ti”), tungsten (“W”), vanadium (“V”), zinc (“Zn”), and zirconium (“Zr”). Such other elements can include, for example, antimony (“Sb”), calcium (“Ca”), magnesium (“Mg”), oxygen (“O”), strontium (“Sr”), and tin (“Sn”).

The doping can comprise, for example, interstitial doping of a crystal structure of at least one 2D or 3D, non-carbon-based topological insulator. Such doping can break the time-reversal symmetry of the at least one 2D or 3D, non-carbon-based topological insulator.

Bi₂Se₃ can be doped, for example, with one or more of Ca, Cr, Cu, Dy, Fe, Gd, Ho, Mg, Mn, Ni, Sb, or Sm (e.g., Bi_{1.84-x}Fe_{0.16}CaₓSe₃ (0≤x<1.84), (HoₓBi₁₋ₓ)₂Se₃ (0≤x≤0.21)). Bi₂Te₃ can be doped, for example, with one or more of Cr, Dy, Fe, Gd, Ho, Mn, Sb, Sm, or Sn (e.g., Cr_{0.08}(Bi_{0.1}Sb_{0.9})_{1.92}Te₃, (DyₓBi₁₋ₓ)₂Te₃ (0<x<1)). Sb₂Te₃ can be doped, for example, with one or both of Cr or Mn. (Bi,Sb)₂Te₃ can be doped, for example, with one or both of Cr or V.

In some examples, substrates are coated with at least one non-carbon-based topological insulator. In some examples, the coated substrate can comprise a substrate surface, and a layer of the at least one non-carbon-based topological insulator directly on the substrate surface.

In some examples, the coated substrate can comprise a substrate surface; and two or more layers of the at least one non-carbon-based topological insulator.

In some examples, a polymer or other final coating can be added to the coated substrate.

In some examples, the coated substrates can be formed using the methods and/or apparatuses discussed above.

Although examples have been shown and described in this specification and figures, it would be appreciated that changes can be made to the illustrated and/or described examples without departing from their principles and spirit, the scope of which is defined by the following claims and their equivalents.

What is claimed is:

1. A method of forming a coating, the method comprising:
preparing a substrate surface with adherent characteristics;
applying a charge of a first polarity to at least one non-carbon-based topological insulator with selected optical transmittance; and
applying the charged at least one non-carbon-based topological insulator to the substrate surface to provide a topological insulator layer on the substrate surface.

2. The method of claim 1, wherein the first polarity is positive.

3. The method of claim 1, wherein the first polarity is negative.

4. The method of claim 1, wherein the preparing of the substrate surface with the adherent characteristics comprises applying charge of a second polarity, different in sign relative to the first polarity, to the substrate surface.

5. The method of claim 4, wherein the first polarity is positive, and
wherein the second polarity is negative or ground.

6. The method of claim 4, wherein the first polarity is negative, and
wherein the second polarity is positive or ground.

7. The method of claim 1, further comprising:
rolling an adhesive roller over the topological insulator layer to remove some, but not all, of the topological insulator layer.

8. The method of claim 1, wherein the at least one non-carbon-based topological insulator comprises a three-dimensional, non-carbon-based topological insulator.

9. A method of forming a coating, the method comprising:
preparing a substrate surface with adherent characteristics;
applying a charge of a first polarity to at least one non-carbon-based topological insulator with selected thermal conductivity; and
applying the charged at least one non-carbon-based topological insulator to the substrate surface to provide a topological insulator layer on the substrate surface.

10. The method of claim 9, wherein the first polarity is positive.

11. The method of claim 9, wherein the first polarity is negative.

12. The method of claim 9, wherein the preparing of the substrate surface with the adherent characteristics comprises applying charge of a second polarity, different in sign relative to the first polarity, to the substrate surface.

13. The method of claim 12, wherein the first polarity is positive, and
wherein the second polarity is negative or ground.

14. The method of claim 12, wherein the first polarity is negative, and
wherein the second polarity is positive or ground.

15. A method of forming a coating, the method comprising:
preparing a substrate surface with adherent characteristics;
applying a charge of a first polarity to at least one non-carbon-based topological insulator with selected electrical conductivity; and
applying the charged at least one non-carbon-based topological insulator to the substrate surface to provide a topological insulator layer on the substrate surface.

16. The method of claim 15, wherein the first polarity is positive.

17. The method of claim 15, wherein the first polarity is negative.

18. The method of claim 15, wherein the preparing of the substrate surface with the adherent characteristics comprises applying charge of a second polarity, different in sign relative to the first polarity, to the substrate surface.

19. The method of claim 18, wherein the first polarity is positive, and
wherein the second polarity is negative or ground.

20. The method of claim 18, wherein the first polarity is negative, and
wherein the second polarity is positive or ground.
